(19) United States
(12) Patent Application Publication
(10) Pub. No.: US 2020/0271254 A1
(43) Pub. Date: Aug. 27, 2020

(54) THERMOPLASTIC FLANGE WITH OVERMOLDED METAL PLATE

(71) Applicant: Flexfab Horizons International, Inc., Hastings, MI (US)

(72) Inventor: Michael A. Martin, Nashville, MI (US)

(73) Assignee: Flexfab Horizons International, Inc., Hastings, MI (US)

(21) Appl. No.: 16/800,365

(22) Filed: Feb. 25, 2020

Related U.S. Application Data
(60) Provisional application No. 62/810,029, filed on Feb. 25, 2019.

(51) Int. Cl. F16L 23/032; F16L 23/22

(52) U.S. Cl. CPC F16L 23/032; F16L 23/22

(57) ABSTRACT

A fitting for attaching a flexible hose to a device includes a conduit body having a first end configured to attach to a flexible hose, and an open second end having an attachment flange. The attachment flange has an annular recess surrounding the open second end a gasket molded into the annular recess. A strengthening member is adjacent the annular recess. The attachment flange is formed of a thermoplastic elastomer and the strengthening member is overmolded by the thermoplastic elastomer.

This application claims the benefit of U.S. Application Ser. No. 62/810,029, filed Feb. 25, 2019, the entirety of which is incorporated herein.

### BACKGROUND

Aspects of the disclosure relate to sealing faces, orifices, gaskets, fluidly sealed couplings or interfaces, or the like. FIGS. 1-5 illustrate an embodiment of the current state of the art. A rigid plastic fitting 10 includes a conduit body 12 having a first end 14 configured to attach to a flexible hose 16, and an open second end 18 having an attachment flange 20 surrounding the open end 18. The flexible hose 16 is typically formed of silicone and is adapted to direct a fluid such as air to a device connected to the attachment flange 20. A typical device 24 might be a booster for an internal combustion engine, such as a turbocharger or an integral supercharged engine. The attachment flange 20 has a plurality of ears 22, each of which has an aperture 26 adapted to receive a bolt (not shown) to affix the flange to the device 24. The attachment flange 20 also includes an annular recess 26 configured to receive a press-in-place (PIP) gasket 28 that will facilitate sealing the conduit body 12 to the device 24.

### SUMMARY OF THE INVENTION

Aspects of the disclosure include a fitting for attaching a flexible hose to a device. The fitting includes a conduit body having a first end configured to attach to a flexible hose, and an open second end having an attachment flange. The attachment flange has an annular recess surrounding the open second end, and a gasket molded into the annular recess. A strengthening member is adjacent the annular recess. The attachment flange is formed of a thermoplastic elastomer and the strengthening member is overmolded by the thermoplastic elastomer.

### BRIEF DESCRIPTION OF THE DRAWINGS

FIG. 1 is an isometric view of a prior art mounting component for a press-in-place (PIP) seal for an intake system.

FIG. 2 is a side view of the mounting component of FIG. 1.

FIG. 3 is bottom view of the mounting component of FIG. 1.

FIG. 4 is a cross sectional view of the mounting component of FIG. 1 taken along lines 4-4 and mounted to a turbocharger.

FIG. 5 is an isometric view of the mounting component of FIG. 1 mounted to a turbocharger.

FIG. 6 is a plan view of one embodiment illustrating aspects of the disclosure, wherein a PIP gasket is molded into a mounting component.

FIG. 7 is a cross sectional view of the embodiment of FIG. 6 taken along lines 8-8 of FIG. 7.

FIG. 8 is a cross sectional view of the embodiment of FIG. 6 taken along lines 9-9 of FIG. 7.

FIG. 9 is an isometric view of a second embodiment of illustrating aspects of the disclosure, wherein a PIP gasket is molded into a mounting component.

FIG. 10 is an isometric view of a strengthening member that is molded into the mounting component.

FIG. 11 a cross sectional view taken along line 11-11 of FIG. 9.

### WRITTEN DESCRIPTION

While “a set” of various elements will be described, it will be understood that “a set” can include any number of the respective elements, including only one element. As used herein, the terms “axial” or “axially” refer to a dimension along a longitudinal axis of an engine or along a longitudinal axis of a component disposed within the engine. As used herein, the terms “radial” or “radially” refer to a dimension extending between a center longitudinal axis of the engine, an outer engine circumference, or a circular or annular component disposed within the engine. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component.

All directional references (e.g., radial, axial, upper, lower, upward, downward, left, right, lateral, front, back, top, bottom, above, below, vertical, horizontal, clockwise, counterclockwise, upstream, downstream) are only used for identification purposes to aid the reader's understanding of the disclosure, and do not create limitations, particularly as to the position, orientation, or use thereof. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto can vary. As shown, the gasket can be in physical contact with, and seal with device 24 such that the rigid plastic pipe is fluidly sealed with the device 24, when bolted together.

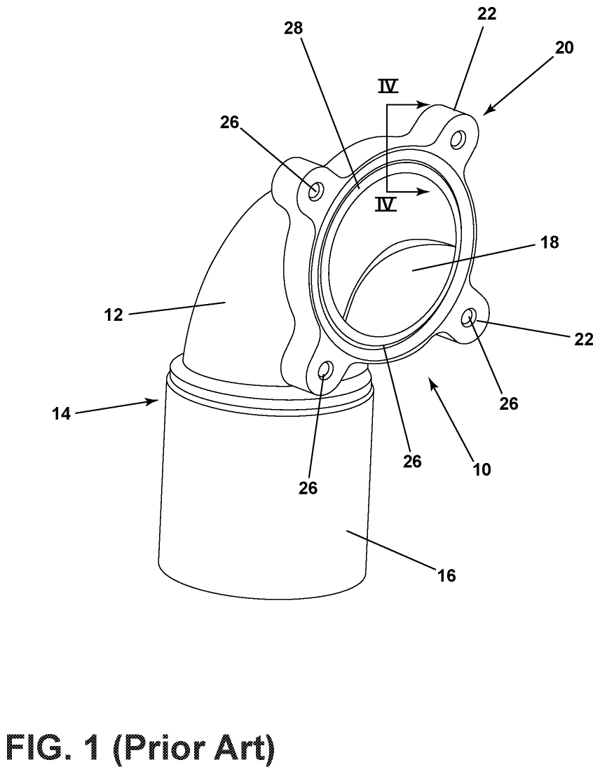

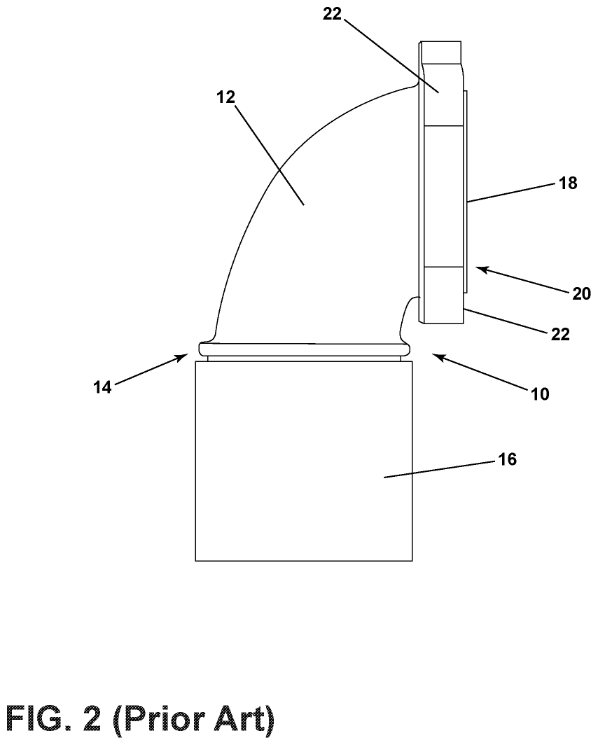

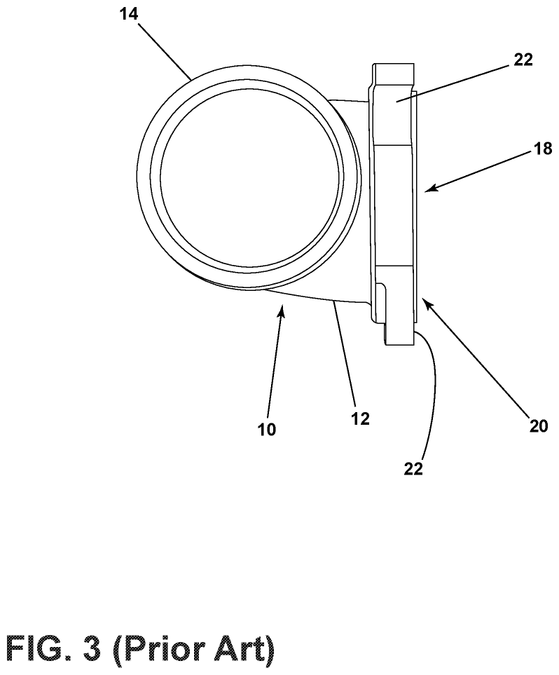

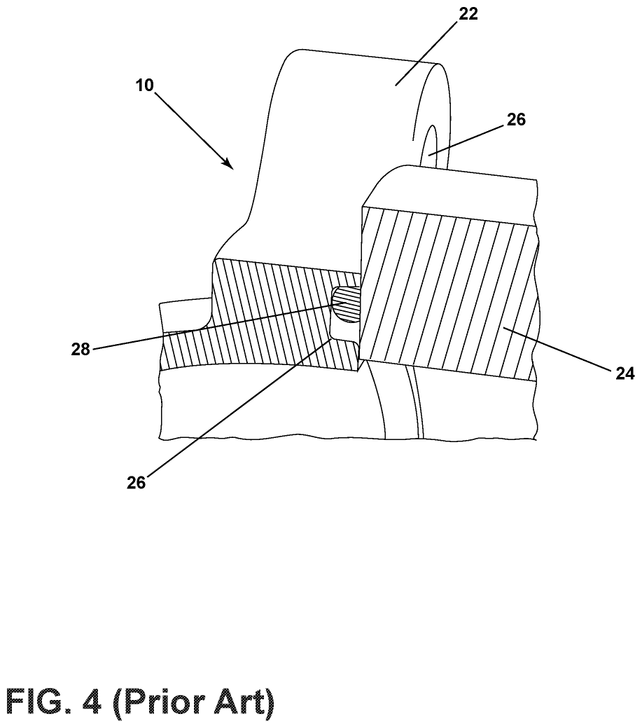

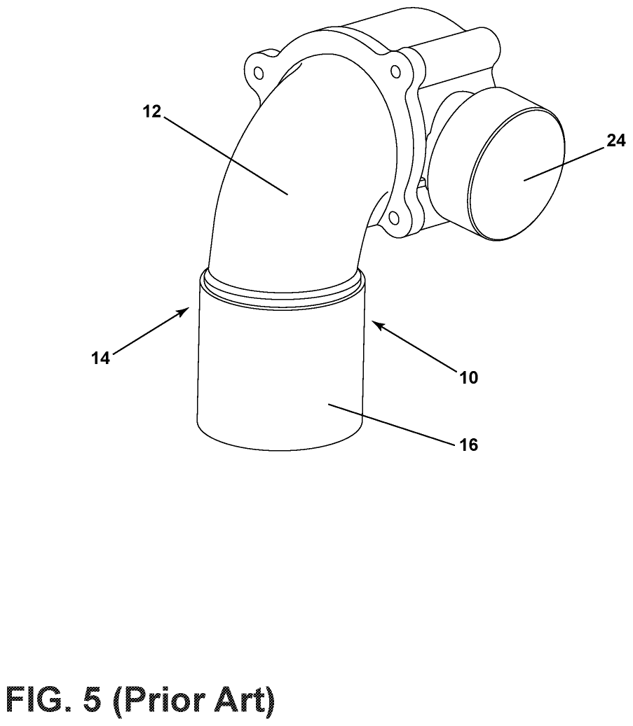

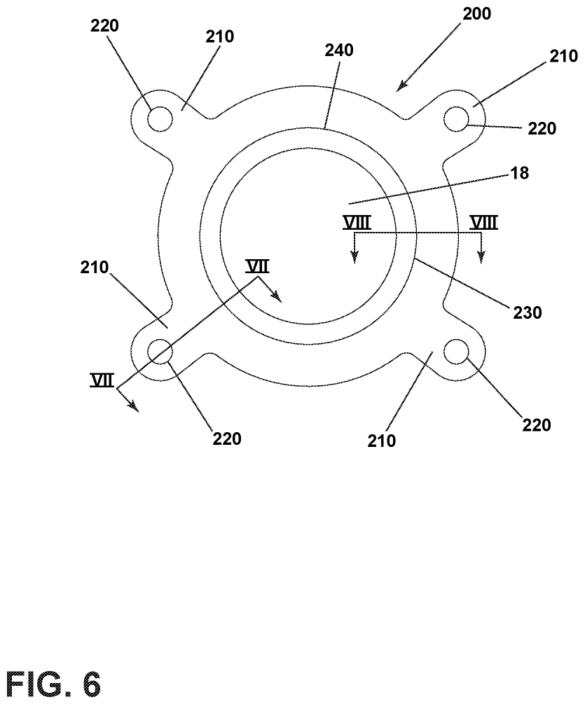

Embodiments of the disclosure bear likenesses to the prior art fitting 10 of FIGS. 1-5 and those similarities will be reflected in like numeral references. FIG. 6 is a plan view of an attachment flange 200 at the open second end 18 of the conduit body 12. The attachment flange 200 includes a plurality of ears 210, each of which has an aperture 220 adapted to receive a bolt (not shown in FIG. 6) to affix the attachment flange 200 to a device 24, such as a turbocharger. The attachment flange 200 also includes an annular recess 230 containing an anural gasket 240. Preferably the attachment flange 200 as well as the remainder of the fitting 10 is formed of a molded thermoplastic elastomer. The gasket is molded with the attachment flange 200 so as to be integral therewith.

The device to which the flange is attached can include a boss, embossment, or another portion extending from a mounting surface, or extending at least in a partial normal direction away from the mounting surface. In one non-limiting example, the extending portion can be strengthened or reinforced to withstand a compressive force acting on the extending portion at least in partially horizontal direction.

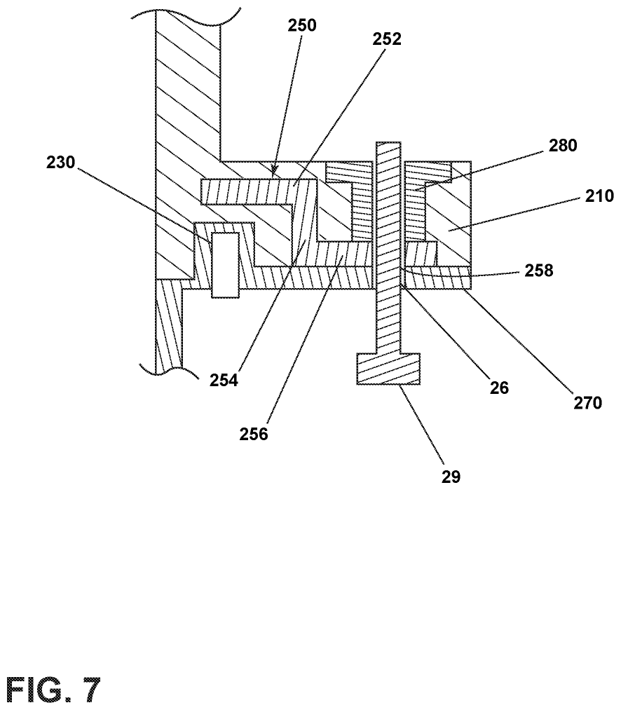

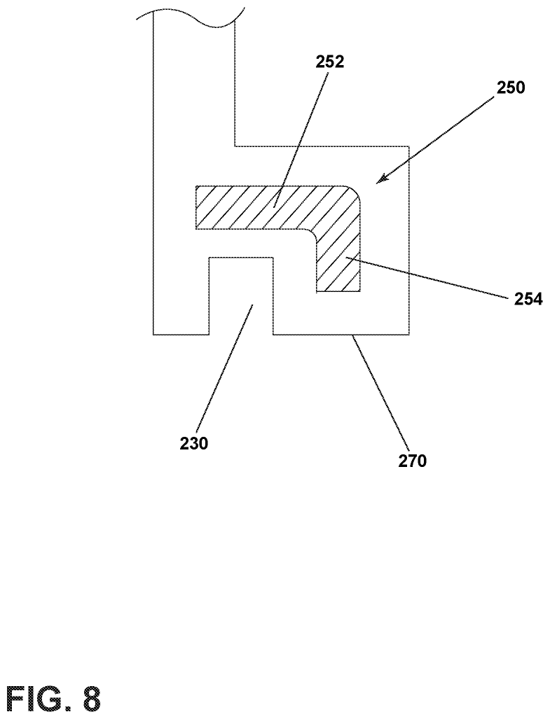

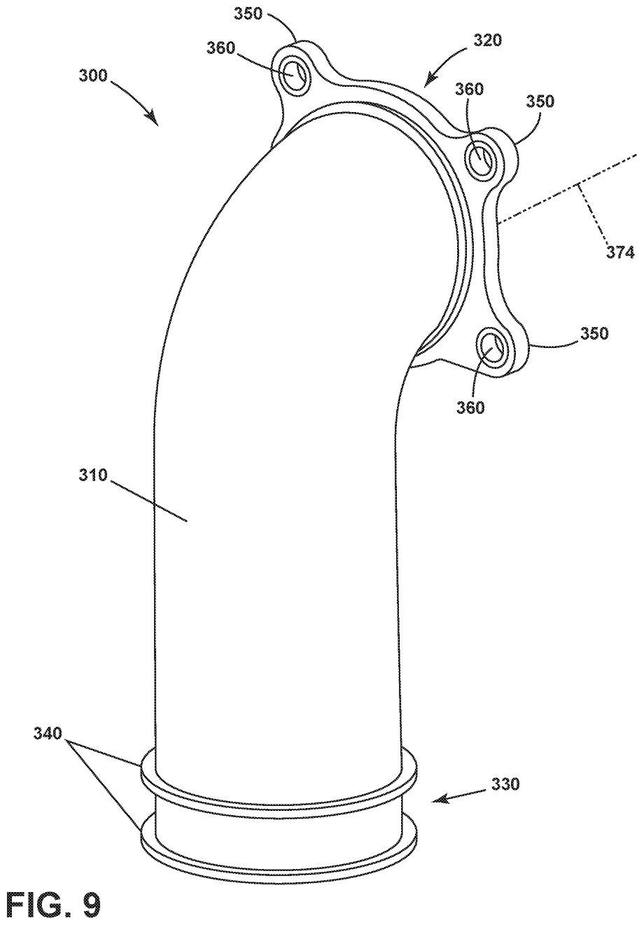

FIG. 9 is similar in construction and description with FIGS. 7 and 8, except shown in a cross-sectional view not including the attachment mechanism. As shown, the thermoplastic elastomer can be fixed relative to another or second component (shown as a device 24), by way of an attachment mechanism, shown as bolt received through a bolt opening. In non-limiting examples, the bolt opening can be threaded to receive a correspondingly threaded bolt, but adhesives, rivets, or any other mechanically fixing attachment mechanisms can be included or employed.

Looking now at FIGS. 7 and 8, the attachment flange 200 can further include a strengthening member 250, which is preferably formed of a more rigid and stronger material than the thermoplastic elastomer of the attachment flange 200. A typical material may be a metal such as steel, or a ceramic or a composite material. In FIG. 7 the strengthening member 250 includes a first portion 252 extending radially outwardly from beneath the annular recess 230 to a point radially outwardly of the annular recess 230, where a second portion 254 then extends normally to near or at an attachment surface 270 of the attachment flange 200. At the ear 210, a third portion 256 of the strengthening member 250 then extends radially outwardly again where an aperture 258 is in registry with the aperture 26 of the ear 210. To facilitate attachment to a device, an internally threaded fastener 280 can be affixed to the third portion around the aperture. Thus, a bolt 29 can be threaded into the fastener 280 through the aperture 258 to secure the attachment flange 200 to the device.

Between the ears as shown in FIG. 8, the strengthening member 250 has only the first and second portions 252, 254. The strengthening member 250 is preferably overmolded by the thermoplastic elastomer, and can act to at least partially resist or withstand a compressive force acting on the attachment flange 200 at least in a partially horizontal direction, such as a normal force of the extending portion received with the extending portion is received within the recess during coupling or joining of the first component with the second component. Optionally, the overmolded strengthening member 250 can turn in a “Z” like shape, or a serpentine shape, and extend to or through portions of the first component not overlying the recess. For example, as shown, the strengthening member 250 can also include an opening for receiving the bolt or attachment mechanism, and at least partially reinforce the attaching of the first component and second component.

As used herein, the term “overmolded” means the strengthening member 250 is overlain, covered, engulfed, wrapped, or otherwise covered in another material of the first component, such as the thermoplastic elastomer. This process can occur during a forming or molding process when manufacturing the first component.

Aspects of the disclosure can be included wherein the strengthening member 250 can be adapted or configured to enable the compressive fitting of the first component and second component, or the extending portion of the second component with the recess of the first component, without deforming portions of the first component. It will be understood that press-fitting thermoplastic elastomer may deform the thermoplastic elastomer relative to a normal force, such as when compressing the first component about the extended portion. The rigidity, supporting, or reinforcing characteristics of the strengthening component of the first component can resist such deforming at the locations where deformation is most likely to occur. Thus, non-limiting aspects of the disclosure can enable or allow for fixing the first component to the second component without deforming the first component. Additional or alternative aspects of the disclosure can also be included wherein the press-fitting of the first component with the second component allows for or enables a fluid-tight attachment without the need for a gasket, due to the recess/extended portion configuration. Optionally, gaskets can still be included, such as received within the recess.

Looking now at FIGS. 9-11 one can see a second embodiment of a fitting 300 that includes a conduit body 310 and an elastomeric attachment flange 320 all molded in a single piece. The conduit body 310 includes a first end 330 with a pair of flanges 340 adapted to be secured to a flexible hose. The attachment flange 320 includes a plurality of flange ears 350, each having an aperture 360 adapted to receive a bolt or the like to secure it to a device such as a turbocharger or an integral supercharged engine.

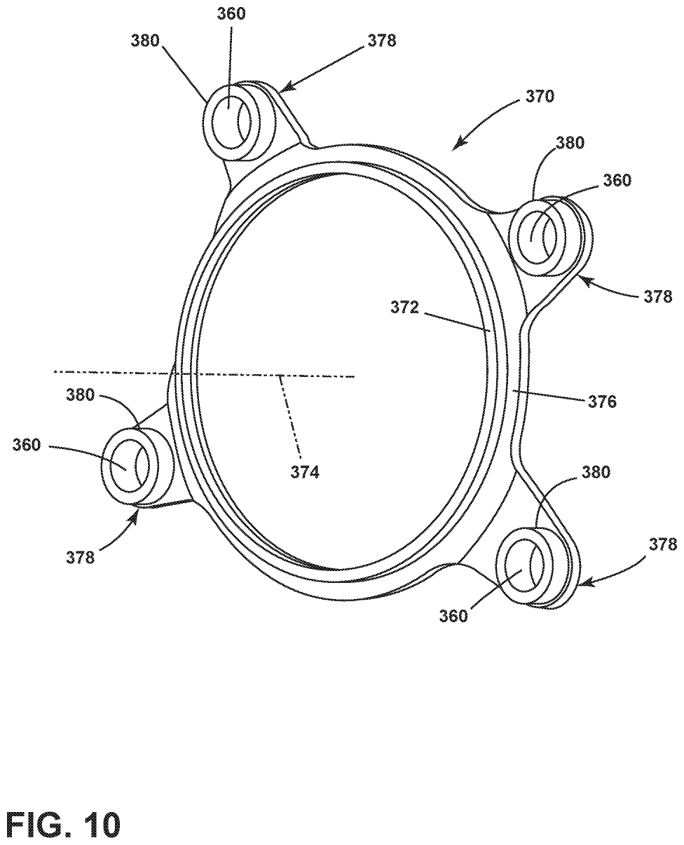

The attachment flange also includes a strengthening member 370 as shown more clearly in FIG. 10. The strengthening member 370 includes a first portion 372 extending axially relative a longitudinal axis 374 of the conduit body 310 at the attachment flange 320. The strengthening member 370 also includes a second portion 376 extending radially from the first portion 372. A set of member ears 378 are spaced circumferentially around the strengthening member 370 and positioned to be overmolded with the flange ears 350. A boss 380 extends axially from each member ear 378 and circumscribes the aperture 360. The strengthening member 370 is preferably formed of a more rigid and stronger material than the thermoplastic elastomer of the attachment flange 320. A typical material may be a metal such as steel, or a ceramic or a composite material.

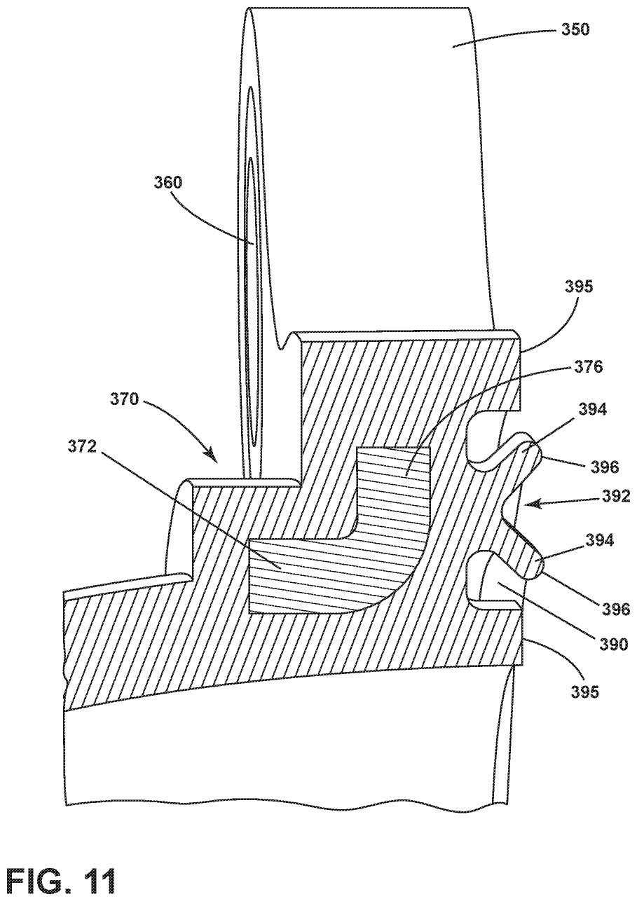

The cross-sectional view of FIG. 11 illustrates the first and second portions 372, 376 of the strengthening member 370 overmolded by the elastomer of the attachment flange 320 between the flange ears 350. Also shown is an annular recess 390 in which a gasket 392 is molded. In the second embodiment, the gasket 392 comprises a pair of arms 394 extending at an angle (roughly in a Y shape) from a base of the annular recess 390. A distal end 396 of each arm extend beyond an attachment surface 395 of the attachment flange 320. The angle of each arm 394 enables the arm to be displaced when the attachment surface 395 abuts a joining surface of a device to which the attachment flange 320 is secured while maintaining a seal between the adjoining surfaces. It will be understood that the gasket 392 may also be used in the first embodiment described above.

Many other possible aspects and configurations in addition to that shown in the above figures are contemplated by the present disclosure. To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

While couplings, interfaces, or the like are described, Aspects of the disclosure can be implemented in any environment, apparatus, or method for fluidly coupling a first aperture, interface, orifice, conduit, or the like, to a second component.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A fitting for attaching a flexible hose to a device, the fitting comprising:
a conduit body having a first end configured to attach to a flexible hose, and an open second end having an attachment flange;
the attachment flange having an annular recess surrounding the open second end;
a gasket molded into the annular recess; and
a strengthening member adjacent the annular recess;
wherein the attachment flange is formed of a thermoplastic elastomer and the strengthening member is overmolded by the thermoplastic elastomer.

2. The fitting of claim 1 wherein the strengthening member includes a first portion extending radially outwardly beneath the annular recess and a second portion extending normal to the first portion radially outwardly beyond the annular recess.

3. The fitting of claim 2 wherein the strengthening member includes a third portion extending radially outwardly from the second portion.

4. The fitting of claim 3 wherein the third portion includes an aperture positioned to be in registry with an aperture in an ear of the attachment flange.

5. The fitting of claim 3 wherein the third portion includes an internally threaded fastener sized to threadedly receive a bolt.

6. The fitting of claim 1 wherein the strengthening member is formed of one of a metal, a ceramic, or a composite material.

7. The fitting of claim 1 wherein the strengthening member includes an internally threaded fastener sized to threadedly receive a bolt.
